(19) United States
(12) Patent Application Publication
(10) Pub. No.: US 2023/0256699 A1
(43) Pub. Date: Aug. 17, 2023

(54) ROLLER SEALING MACHINES HAVING WIDE BACKING ROLLERS

(71) Applicant: Sealed Air Corporation (US), Charlotte, NC (US)

(72) Inventor: Christian Theodore Lomascolo, Mooresville, NC (US)

(21) Appl. No.: 18/015,247

(22) PCT Filed: Jul. 7, 2021
(86) PCT No.: PCT/US2021/040604

§ 371 Date: Jan. 9, 2023

Related U.S. Application Data
(60) Provisional application No. 63/050,993, filed on Jul. 13, 2020.

(51) Int. Cl. B31D 5/00

(52) U.S. Cl. CPC B31D 5/0073; B31D 2205/0082

(57) ABSTRACT

A system is capable of advancing and sealing a web of inflatable containers. The system includes a sealing roller that includes a sealing element located around a circumferential surface of the sealing roller. The system also includes a backing roller positioned with respect to the sealing roller to form a nip between a circumferential surface of the backing roller and the circumferential In surface of the sealing roller. When the longitudinal edge of the web is located in the nip, the sealing roller and backing roller counterrotate to advance the web. The circumferential surface of the backing roller extends axially farther into the web than the circumferential surface of the sealing roller extends axially into the web such that backing roller contacts the web at a transverse location that is farther away from the longitudinal edge of web than the sealing roller contacts the web.

### BACKGROUND

The present disclosure is in the technical field of inflated containers, such as inflated packaging cushions. More particularly, the present disclosure is directed to a simplified and improved machine for consistently producing the same.

Various machines for forming inflated cushions, pillows, or other inflated containers are known. For packaging applications, inflated cushions are used to package items, by wrapping the items in the cushions and placing the wrapped items in a shipping carton, or simply placing one or more inflated cushions inside of a shipping carton along with an item to be shipped. The cushions protect the packaged item by absorbing impacts that may otherwise be fully transmitted to the packaged item during transit, and also restrict movement of the packaged item within the carton to further reduce the likelihood of damage to the item.

Earlier machines for forming inflated cushions tended to be rather large, expensive, and complex. More recently, smaller, less-expensive inflation machines have been developed, which employ inflatable webs having pre-formed containers. Many such machines, however, suffer from alignment and tracking problems of the inflatable web as it moves through the machine, resulting in poorly-inflated, non-inflated, and/or poorly-sealed cushions, which lead to web wastage and/or cushions that deflate prematurely or otherwise fail to protect the packaged product. Also, such machines have less-than-optimal web-loading, web-feeding, and web-sealing mechanisms. With respect to the latter, poorly-formed and/or incomplete heat-seals typically results in deflation of the cushions. In particular, the process of forming heat-seals can cause the web to tear, stretch, or deform under certain circumstances, which can allow some or all of the gas to escape the containers. Unfortunately, this action has been found to frequently result in partial or full deflation of cushions, which can lead to product damage during shipment and/or storage due to ineffective product protection in the subsequently-formed package.

Accordingly, there remains a need for simple and reliable machines for producing gas-filled containers that are suitable for use as packaging cushions, which address and overcome one or more of the foregoing operational issues.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a first embodiment, a system is configured to advance and seal a web of inflatable containers. The containers include ports along a longitudinal edge of the web. The system includes a sealing roller and a backing roller. The sealing roller includes a sealing element located around a circumferential surface of the sealing roller. The backing roller is positioned with respect to the sealing roller to form a nip between a circumferential surface of the backing roller and the circumferential surface of the sealing roller. At least one of the sealing roller and backing roller is driven such that, when the longitudinal edge of the web is located in the nip, the sealing roller and backing roller counterrotate to advance the web. The circumferential surface of the backing roller extends axially farther into the web than the circumferential surface of the sealing roller extends axially into the web such that backing roller contacts the web at a transverse location that is farther away from the longitudinal edge of web than the sealing roller contacts the web.

In a second embodiment, the backing roller of the first embodiment includes a rubber material and the circumferential surface of the backing roller is made from the rubber material.

In a third embodiment, the sealing roller and the backing roller of any of the previous embodiments are arranged such that an axis of the sealing roller and an axis of the backing roller are substantially parallel to each other.

In a fourth embodiment, the system of the third embodiment is part of an inflation machine. The axis of the sealing roller and the axis of the backing roller are arranged at an inclined angle with respect to a surface on which the inflation machine is located.

In a fifth embodiment, the surface on which the inflation machine is located in the fourth embodiment is substantially horizontal.

In a sixth embodiment, the backing roller of the any of the previous embodiments includes an outer transverse edge and an outer transverse edge, and wherein the inner transverse edge faces the containers of the web when the web is advanced, and wherein the backing roller is located with respect to the sealing roller such that the inner transverse edge is positioned farther away from the sealing element than the outer transverse edge

In a sixth embodiment, the circumferential surface of the backing roller of any of the previous embodiments extends beyond the nip between the circumferential surface of the backing roller and the circumferential surface of the sealing roller.

In an eighth embodiment, a percentage of the circumferential surface of the backing roller that extends beyond the nip of the sixth embodiment is greater than or equal to at least one of 5%, 7.5%, 10%, or 12.5%.

In a ninth embodiment, the system of any of the previous embodiments further includes a nozzle arranged to inflate the containers of the web before the web is advanced to the sealing roller and the backing roller.

In a tenth embodiment, the nozzle of the ninth embodiment is offset with respect to the nip between the circumferential surface of the backing roller and the circumferential surface of the sealing roller such that, as the web is advanced by the sealing roller and the backing roller, the web contacts the backing roller before contacting the sealing roller.

In an eleventh embodiment, the sealing element of any of the previous embodiments has a helical shape around the circumferential surface of the sealing roller.

In a twelfth embodiment, the sealing element of any of the first to tenth embodiments has an annular shape around the circumferential surface of the sealing roller.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIGS. 1A and 1B depict, respectively, an example of a machine for inflating and sealing webs of inflatable containers and the same machine being used to inflate and seal an inflatable web;

FIGS. 2A and 2B depict, respectively, another example of a machine for inflating and sealing webs of inflatable containers and the same machine being used to inflate and seal an inflatable web;

FIG. 3 depicts a front view of an embodiment of a system for advancing and sealing a web of inflatable containers;

FIG. 4 depicts a side view of the system shown in FIG. 3 in which the inflation nozzle is visible in greater detail;

FIG. 5 depicts an exploded front view of the system shown in FIG. 3 with the sealing roller and the backing roller spaced apart from each other;

FIG. 6 depicts an embodiment of the system shown in FIG. 3 being arranged at an upward angle with respect to horizontal;

FIG. 7 depicts a detail view of the web and the nip between the sealing roller and the backing roller of the system shown in FIG. 3;

FIG. 8 depicts a view of the web shown in FIG. 7, but with the system removed to more clearly show the state of the web;

FIG. 9 depicts a front view of an embodiment of a system for advancing and sealing a web of inflatable containers, in accordance with the embodiments disclosed herein;

FIG. 10 depicts a side view of the system shown in FIG. 9 in which the inflation nozzle is visible in greater detail, in accordance with the embodiments disclosed herein;

FIG. 11 depicts an exploded front view of the system shown in FIG. 9 with the sealing roller and the backing roller spaced apart from each other, in accordance with the embodiments disclosed herein;

FIG. 12 depicts an embodiment of the system shown in FIG. 9 being arranged at an upward angle with respect to horizontal, in accordance with the embodiments disclosed herein;

FIG. 13 depicts a detail view of the web and the nip between the sealing roller and the backing roller of the system shown in FIG. 9, in accordance with the embodiments disclosed herein; and

FIG. 14 depicts a view of the web shown in FIG. 13, but with the system removed to more clearly show the state of the web, in accordance with the embodiments disclosed herein.

### DETAILED DESCRIPTION

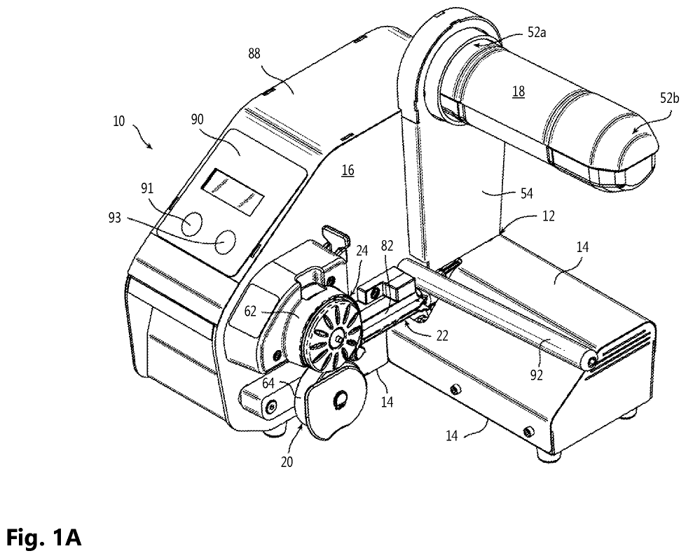

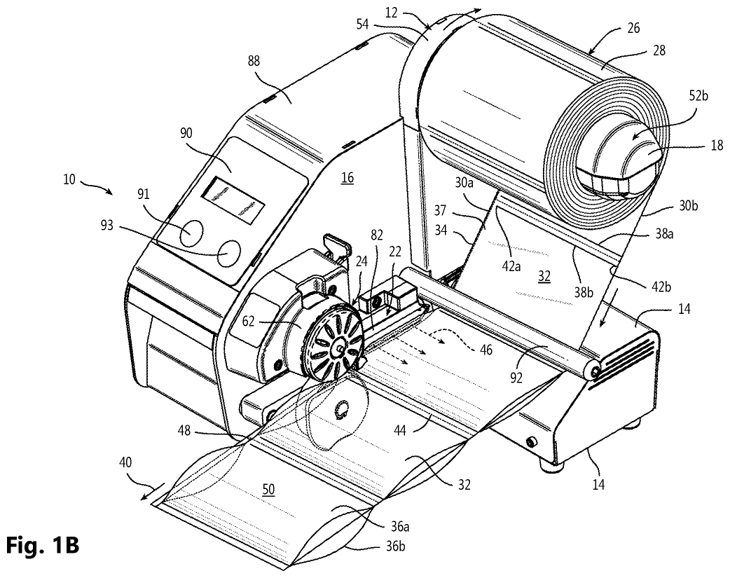

FIGS. 1A depicts an example of a machine 10 for inflating and sealing webs of inflatable containers. The machine 10 includes a support structure 12, which may comprise a base 14 and a wall 16 extending upwards from the base. The machine 10 further includes a spool 18 for rotatively supporting a roll of the inflatable web, a web conveyance system 20 for conveying the inflatable web along a path of travel 40, an inflation system 22 for inflating the inflatable web (and the containers therein), and a sealing device 24 located proximate to the inflation system 22 for sealing closed the inflated containers.

FIG. 1B depicts the machine 10 being used to inflate and seal an inflatable web 26. The web 26 is in the form of a roll 28, which is rotatively supported by spool 18. The web 26 has opposing first and second longitudinal edges 30a and 30b, and includes a series of inflatable containers 32. Each of the containers 32 is capable of holding therein a quantity of gas (e.g., air) and each has an opening 34 at the first edge 30a for receiving the gas.

The web 26 may further comprise a pair of juxtaposed sheets 36a and 36b (e.g., film sheets). In the illustrated embodiment, first longitudinal edge 30a of the web 26 is open (e.g., unsealed), while second longitudinal edge 30b is closed, (e.g., sealed or folded). The web conveyance system 20 conveys the inflatable web 26 along a path of travel 40, which is substantially parallel to the longitudinal edges 30a and 30b of the inflatable web 26.

The containers 32 may be defined between sheets 36a and 36b and between a series of transverse seals 38. The seals 38 are described as “transverse” because they are aligned in a direction that is generally transverse to the longitudinal edges 30a and 30b of web 26 and path of travel 40. As shown in FIG. 1B, the seals 38 may be arranged as relatively closely-spaced pairs 38a and 38b, such that each chamber 32 is defined in the web 26 between a leading transverse seal 38a from a downstream pair of seals 38, and a following transverse seal 38b from an adjacent, upstream pair of such seals. In other words, from the perspective of the closely-spaced seal-pairs, the upstream transverse seal of each seal-pair is designated 38a while the downstream seal is designated 38b.

The openings 34 of the containers 32 are formed by the open first edge 30a of the web 26 and the first ends 42a of the transverse seals 38. The opposing second ends 42b terminate at the closed second edge 30b. The first ends 42a of the transverse seals are spaced from first edge 30a, in order to form a pair of opposing open (unattached) flanges in sheets 36a and 36b that form an “open skirt” region 37, which allows inflation system 22 (e.g., nozzle 82 thereof) to be accommodated within web 26 (e.g., between film sheets 36a and 36b) in order to facilitate inflation. Examples of such webs are disclosed, for example, in U.S. Pat. No. 6,651,406, the contents of which are hereby incorporated herein by reference. In order to allow individual or groups of inflated containers to be separated from the web 26, a line of weakness 44, such as a perforated line, may be included between each chamber 32. For example, a line of weakness 44 can be located between each upstream/downstream pair of transverse seals 38a and 38b, as shown in the depicted embodiment.

Inflatable web 26 may, in general, comprise any flexible film material that can be manipulated by the machines described herein (e.g., machines 10, 100) to enclose a gas or fluid 46 as herein described, including various thermoplastic materials, e.g., polyethylene homopolymer or copolymer, polypropylene homopolymer or copolymer, etc. Non-limiting examples of suitable thermoplastic polymers include polyethylene homopolymers, such as low density polyethylene (LDPE) and high density polyethylene (HDPE), and polyethylene copolymers such as, e.g., ionomers, EVA, EMA, heterogeneous (Zeigler-Natta catalyzed) ethylene/alpha-olefin copolymers, and homogeneous (metallocene, single-cite catalyzed) ethylene/alpha-olefin copolymers. Ethylene/alpha-olefin copolymers are copolymers of ethylene with one or more comonomers selected from C3 to C20 alpha-olefins, including linear low density polyethylene (LLDPE), linear medium density polyethylene (LMDPE), very low density polyethylene (VLDPE), and ultra-low density polyethylene (ULDPE). Various other polymeric materials may also be used such as, e.g., polypropylene homopolymer or polypropylene copolymer (e.g., propylene/ethylene copolymer), polyesters, polystyrenes, polyamides, polycarbonates, etc. The film may be monolayer or multilayer and can be made by any known extrusion process by melting the component polymer(s) and extruding, coextruding, or extrusion-coating them through one or more flat or annular dies.

As shown in FIG. 1B, the web conveyance system 20 advances the web 26 along the path of travel 40 beside the wall 16, with the web being oriented such that the first edge 30a thereof is adjacent to the wall 16. The inflation system 22 is positioned to direct gas 46, as indicated by arrows, into the openings 34 of the containers or chambers 32 as the web 26 is advanced along the path 40, thereby inflating the containers.

As also shown in FIG. 1B, the sealing device 24 may be positioned just downstream of the inflation system 22 so that the sealing device 24 substantially contemporaneously seals closed the openings 34 of the containers 32 as they are being inflated. The sealing device 24 may seal closed the openings 34 by producing a longitudinal seal 48 between film sheets 36a and 36b, which also intersects transverse seals 38a and 38b near the first ends 42a to enclose gas 46 within the containers 32. In this manner, the inflatable containers 32 of the web 26 are converted into inflated containers 50.

In the embodiment depicted in FIGS. 1A and 1B, the spool 18 has a proximal end 52a, at which the spool is attached to support structure 12, and an opposing distal end 52b, which is spaced from the support structure 12. In some embodiments, the distal end 52b may have a higher elevation relative to the proximal end 52a. In this way, when the machine 10 is placed on a substantially horizontal surface, the spool 18 may have an upward angle as the spool 18 extends away from the wall 16. In this manner, when a web roll 28 is mounted thereon, the roll 28 is gravitationally biased towards the support structure 12. Such upward angle of spool 18 may facilitate the manual act of loading a new web roll 28 onto the spool, as the upward angle is often more ergonomic for roll loading, and with gravity assisting in sliding the roll all the way onto the spool 18. The degree of elevation of the distal end 52b of spool 18 may be such that the upward angle of the spool relative to a horizontal plane is between about 1 to about 45 degrees, such as from about 2 to about 30 degrees, about 3 to about 20 degrees, and so forth. As an example, an upward angle of about 4 degrees above horizontal may be suitable.

For those embodiments in which the spool 18 has an upwardly-angled configuration, the resultant gravitational bias of the roll 28 towards the support structure 12 urges the first longitudinal edge 30a of the web 26 towards the web conveyance system 20, the inflation system 22, and the sealing device 24. The gravitational bias of the roll 28 towards the support structure 12 has the potential, therefore, to facilitate the reliability of machine 10 by improving the tracking of the open edge of the web 26 through the inflation and sealing operations. In order to accommodate the weight and diameter of a full roll 28, the support structure 12 may include an upright structural bracket 54, to which spool 18 may be directly attached (e.g., via fasteners). As depicted, the upright bracket 54 may be secured to wall 16 of support structure 12, and may serve to elevate spool 18 such that there is sufficient space between the spool 18 and the base 14 to accommodate the roll 28 having a desired maximum, full-width diameter.

In the depicted embodiment, the distal end 52b of the spool 18 is unsupported such that the spool is cantilevered from upright bracket 54 on wall 16. Alternatively, the distal end 52b may be supported by a suitable structural component, such as an upstanding post with a cradle on which the distal end 52b rests. It may be desirable to support the distal end 52b of the spool 18 in embodiments where large and/or heavy web rolls will be used.

As noted above, the sealing device 24 is configured to seal closed the openings 34 of containers 32 by producing a longitudinal seal 48 between the film sheets 36a and 36b. The longitudinal seal 48 intersects transverse seals 38a and 38b near the first ends 42a to enclose the gas 46 within the containers 32. In this manner, the inflatable containers 32 of the web 26 are converted into inflated containers 50.

In the depicted embodiment, the sealing device 24 and the web conveyance system 20 are incorporated together as an integrated assembly. In some embodiments, the integrated assembly of the sealing device 24 and the web conveyance system 20 includes a pair of convergent, counter-rotating rotary members. In the depicted embodiment, the pair of rollers includes a sealing roller 62 and a backing roller 64. The sealing roller 62 includes a sealing element located around a circumferential surface of the sealing roller 62. The sealing and backing rollers 62 and 64 may be positioned such that a nip (e.g., an area of tangential contact) is formed therebetween. At least one of the sealing roller 62 and the backing roller 64 may be coupled to a motor (e.g., a motor and gearbox assembly), such that, when power is supplied to one or both of the sealing and backing rollers 62 and 64 and the web 26 passes through the nip 65, the sealing and backing rollers 62 and 64 counterrotate so that the web 26 is advanced along the path 40. As the web 26 is conveyed, the sealing element on the sealing roller 62 forms the longitudinal seal 48 at the nip between the sealing and backing rollers 62 and 64 to close the openings 34 of the inflated containers 32/50.

The sealing element may be an electrically-heated resistive device, such as a band or wire, which generates heat when an electrical current passes through the device. The sealing element may be mounted on the circumferential outer surface. When the sealing element is heated and the sealing and backing rollers 62 and 64 counter-rotate compressively against the web 26, the rotational contact between the sealing element and the web 26 forms the longitudinal seal 48 as the web 26 is conveyed along its path of travel 40.

In some embodiments, the sealing element is in the form of a wire. The sealing roller 62 may be formed from any material that is capable of withstanding the temperatures generated by the sealing element, such as metal (e.g., aluminum), high-temperature-resistant polymers (e.g., polyimide), ceramics, and the like. A groove may be provided in the circumferential surface of the sealing roller 62 to accommodate sealing element and keep it in proper position on the circumferential surface during sealing and conveyance.

The circumferential surface may include a roughened or knurled section to facilitate traction between the circumferential surface and the web in order to prevent or minimize slippage between the sealing roller 62 and the web 26 as the sealing roller 62 rotates against the web 26 to convey it along path 40. Web traction between the sealing and backing rollers 62 and 64 may further be facilitated by forming the backing roller 64 from a pliant material, such as rubber or RTV silicone.

Additional details regarding integrated web conveyance systems, sealing devices, and other components described herein are disclosed in one or more of U.S. Pat. Nos. 7,225,599; 8,991,141; 10,286,617; and U.S. Patent Application Publication No. 2019/0009476 A1, the contents of each of which are hereby incorporated by reference in their entirety.

In the depicted embodiment, the longitudinal seal 48 is oriented in a direction that is substantially parallel to the longitudinal edges 30a and 30b of the web 26 and its direction of movement along its path of travel 40 through the machine 10. The longitudinal seal 48 may, as shown, be a continuous longitudinal seal (e.g., a substantially linear, unbroken seal, which is interrupted only when the sealing device 24 is caused to stop making the seal. Alternatively, the sealing device 24 may be adapted to produce longitudinal seal 48 as a discontinuous series of longitudinal seal segments. A discontinuous series of longitudinal seal segments may be produced when sealing element 66 has a helical pattern on surface 72 of the sealing roller 62, resulting in an angled configuration of the longitudinal seal segments, such as is disclosed in U.S. Pat. No. 7,225,599. As a further alternative, sealing element may be arranged on sealing roller 62 as an overlapping helical pattern (e.g., as a “double helix,” as disclosed in U.S. Pub. No. 2008/0250753 A1, the contents of which are hereby incorporated by reference in their entirety.

The machine 10 may include a housing 88, such as on the opposite side of wall 16 from that with which the web-handling components (e.g., the spool 18, the inflation system 22, the rollers 62 and 64, etc.) are associated. The housing 88 may contain various operational devices, some of which are described above (e.g., the motor), and some of which will be described below. The housing 88 may also contain thereon an operator interface, such as a control panel 90. In some embodiments, the control panel 90 includes at least a start button or switch 91 and a stop button or switch 93, which allow the operator of the machine 10 to cause the machine 10 to start operations and stop operations, respectively.

The machine 10 (or any of the embodiments of the machines disclosed herein) may further include a controller configured to control the overall operation of the machine 10. The controller may be contained within housing 88. The controller may be in operative 0 communication with the various sub-assemblies of machine 10, inter alia, to control the flow of power (e.g., electricity) thereto. Such control may take place indirectly (e.g., by controlling the flow of power to the sub-assemblies from a separate power management source), or directly.

When web 26 is in the form of a roll 28 as shown, the force required to withdraw the web from the roll by web conveyance system 20 may change as the roll is depleted, such that the tension in web 26 may vary as the roll depletes. Such variation in web tension can contribute to misalignment of the web vis-à-vis the inflation system 22 and sealing device 24. Such misalignment can result in a number of inflation and/or sealing problems, including non-inflation of the containers, under-inflation of the containers, and seal failures. Accordingly, the machine 10 may further include one or more tension-control devices for controlling the tension in the web 26 as it is conveyed along path 40 through the machine. Such devices may operate by applying frictional resistance to the web 26 in opposition to the advancement thereof by the conveyance system 20.

One such device is illustrated in FIGS. 1A and 1B, where a tension rod or arm 92 may be positioned between the roll 28 and the inflation system 22. The tension rod 92 may be structured and arranged to be in contact (e.g., sliding contact) with the web 26 as it is conveyed along the path 40. The sliding contact between the tension rod 92 and the web 26 provides frictional resistance to the web 26 in opposition to its advancement along path 40. The magnitude of such frictional resistance is directly proportional to the extent of the contact between the web 26 and the tension rod 92. In the depicted arrangement, as the diameter of roll 28 decreases with depletion of its supply of web 26, the area of contact between web 26 and rod 92 increases, based on the increased angle of approach of the web onto the tension rod from roll 28. Conveniently, the tension rod 92 may also provide the function of a guide rod, in that it directs the web 26 into proper position on inflation nozzle 82. The tension rod 92 may have a substantially round or oval cross-sectional shape as shown. It will be understood that the tension rod 92 could have various other cross-sectional shapes (e.g., square, rectangular, triangular, etc.).

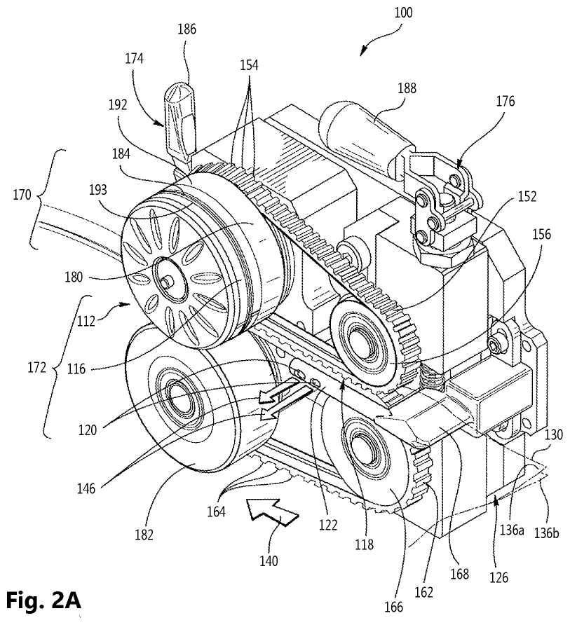

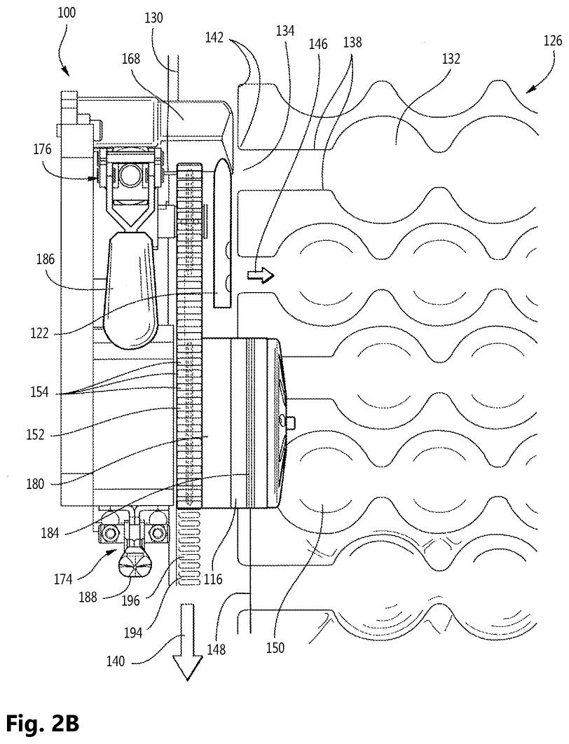

FIGS. 2A and 2B depict another embodiment of a machine 100 for inflating and sealing an inflatable web or inflatable web 126. The machine 100 generally comprises a drive 112, an inflation nozzle 122, a sealing device 116, and a sheet engagement device 118. The drive 112 may comprise a sealing roller 180 and a backing roller 182, which may be positioned such that a nip—an area of tangential contact—is formed therebetween when the drive roller and the backing roller contact. At least one of the rollers, such as the sealing roller 180, may be linked to a motor to form the drive 112 such that, when power is supplied to the motor, the drive roller rotates. When the sealing roller 180 is in contact with the backing roller 182, the backing roller may also rotate. As will be described in detail below, this may advance the inflatable web 126. The outer surface 192 of the sealing roller 180 may be roughened or knurled to facilitate traction with the inflatable web 126 to minimize slippage as the drive roller rotates against the inflatable structure to advance the inflatable structure in a machine direction 140. To further facilitate advancing of the inflatable web 126, the backing roller 182 may be formed from a pliant material, such as rubber or RTV silicone. Other materials, such as metal with a knurled surface, may also be used for the backing roller 182 as desired, particularly when the backing roller is mounted to the machine 100 using a suspension system which ensures that the backing roller properly contacts the sealing roller 180 and the sealing device 116 during operation.

The sheet engagement device 118 may be configured to engage a first sheet 136a and a second sheet 136b forming the inflatable web 126 together along a longitudinal edge 130 of the inflatable web 126. For example, in the depicted embodiment, the sheet engagement device 118 includes a first belt 152 defining a plurality of teeth 154 and an opposing second belt 162 defining a plurality of teeth 164. The first belt 152 extends around the sealing roller 180 and also extends around an engaging roller 156. The opposing second belt 162 extends around the backing roller 182 and also extends around an opposing roller 166. Further, the teeth 154 and 164 of the first belt 152 and the opposing second belt 162 may be oriented such that they face outwardly from a first external surface of the first belt 152 and a second external surface of the opposing second belt 162 and such that they do not touch the respective rollers 180, 156, 182, 166. Instead, the teeth 154 from the first belt 152 engage the teeth 164 from the opposing second belt 162 in an intermeshing manner. The sheet engagement device 118 may be rotationally coupled to the drive 112 such that, when the motor rotates the drive (including the sealing roller 180), the sheet engagement device 118 also rotates. In alternate embodiments, instead of using a driver roller, the sheet engagement device may serve as the drive for the inflatable structure, with the two belts advancing the inflatable structure in the machine direction. In such embodiments, a non-rotary sealing device, such as a flat sealing bar and other similar known sealing devices may be used to seal the inflatable structure.

Although the teeth 154 and 164 are shown as being oriented generally perpendicular to the machine direction 140, the teeth 154 and 164 may be oriented in other directions. For example, the teeth 154 and 164 could be arranged longitudinally such that they generally align with the machine direction 140. In such a configuration, when one of the first belt 152 or the opposing second belt 162 has longitudinally oriented teeth, the other of the first belt and the second belt may comprise one or more longitudinally extending grooves. In such an embodiment, the longitudinally extending teeth may engage the one or more longitudinally extending grooves. In alternate embodiments, one or both of the first external surface of the first belt 152 and the second external surface of the opposing second belt 162 may be untoothed.

In the depicted embodiment, the machine 100 further includes an inflation nozzle 122 for inflating the inflatable web 126 with a fluid 146. The inflation nozzle 122 may be positioned such that the sheet engagement device 118 is adjacent to the inflation nozzle, which aids in inflation of the inflatable web 126. The inflation nozzle 122 may take many different forms. The inflation nozzle 122 includes an outlet 120. The location of the outlet 120 may affect the effectiveness of the inflation of the inflatable web 126. The inflation nozzle 122 may be adjacent to the sheet engagement device 118, such as with the first belt 152 and the second belt 162 positioned between the nozzle 122 and the remainder of the machine 100. The machine 100 may further include a plow 168 that separates the first sheet 136a of the inflatable web 126 from the second sheet 136b of the inflatable structure. Such a plow 168 may include an integral portion of the nozzle 122, as shown in the embodiment of the machine 100 depicted in FIGS. 2A and 2B. Alternatively, the plow 168 may be a component of the machine 100 separate from the inflation nozzle 122. In some alternate embodiments, the nozzle 122 may comprise a tubular structure which separates the first sheet 136a and the second sheet 136b.

The machine 100 may further define an engaging assembly 170 and an opposing assembly 172. The engaging assembly 170 may comprise the sealing roller 180, the sealing device 116, the engaging roller 156, and the first belt 152. The opposing assembly 172 may comprise the backing roller 182, the opposing roller 166, and the second belt 162. In the depicted embodiment, the machine 100 further includes release mechanisms 174 and 176 to which all or a portion of the opposing assembly 172 and/or the engaging assembly 170 is mounted. The release mechanisms 174 and 176 allow the opposing assembly 172 to be moved relatively toward and away from the engaging assembly 170. For instance, a first release mechanism 174 may displace the backing roller 182 from the sealing roller 180 and sealing device 116, and conversely back into contact with the drive roller and sealing device. Similarly, a second release mechanism 176 may move the opposing roller 166 away from the engaging roller 156, and conversely back into contact with the engaging roller.

In the depicted embodiment, the sealing device 116 is located on the sealing roller 180. The sealing device 116 includes a sealing element 184. The sealing element 184 may be a resistive element, which produces heat when electricity is supplied thereto, and can have any desired shape or configuration. As shown, the sealing element 184 is in the form of a wire. Thus, the sealing device 116 may be formed from any material that is capable of withstanding the temperatures generated by the sealing element 184, such as metal (e.g., electrically-insulated aluminum), high-temperature-resistant polymers (e.g., polyimide), ceramics, and the like. A groove 193 in the circumferential surface of the sealing roller 180 may be provided to accommodate the sealing element 184 and keep it in proper position to seal the inflatable web 126. The engaging assembly 170 has a sealing device 116 with a sealing element 184 to engage the backing roller 182 from the opposing assembly 172 to seal the inflatable web 126 which travels therebetween.

FIG. 2B illustrates a top view of the machine 100 being used to inflate and seal the inflatable web 126. In the illustrated embodiment, the inflatable web 126 has a longitudinal edge 130 and includes a series of pre-formed inflatable containers or chambers 132 formed between the first sheet 136a and the second sheet 136b. Each of the inflatable containers 132 is capable of holding therein a quantity of fluid 146 (e.g., air or another gas) and each of the inflatable containers 132 has an opening 134 at the longitudinal edge 130 for receiving such fluid. As illustrated in FIG. 2B, the inflatable containers 132 may be defined between transverse seals 138. The openings 134 of the inflatable containers 132 are formed near the longitudinal edge 130 of the inflatable web 126 at the ends 142 of the transverse seals 138. The ends 142 of the transverse seals 138 are spaced from the longitudinal edge 130, in order to accommodate the inflation nozzle 122 within the inflatable web 126 (e.g., between the sheets 136a and 136b) while the other ends of the transverse seals terminate at a closed edge of the inflatable web 126. The closed edge could be either a fold forming the first sheet 136a and the second sheet 136b, such as when a single piece of film forms the inflatable web 126, or the closed edge could comprise a seal between separate sheet materials that have been joined together.

To begin the operation, an inflatable web 126 is fed between the engaging assembly 170 and the opposing assembly 172 from, for example, a roll of the inflatable structure stored on a spool, such as any of the spools and the associated systems or features described herein. In some embodiments, one or more of the spool, the engaging assembly 170, and/or the opposing assembly 172 may form an angle with respect to horizontal such that the closed edge of the inflatable web 126 sits at a higher elevation than the longitudinal edge 130 of the inflatable structure as the inflatable structure is advanced through the machine 100. In such embodiments the alignment of the longitudinal edge 130 with the machine direction 140 may be improved.

The feeding of the inflatable web 126 between the engaging assembly 170 and the opposing assembly 172 may also be facilitated by using the release mechanisms 174 and 176. As described above, the second release mechanism 176 may move the opposing roller 166 downwardly away from the engaging roller 156, and the first release mechanism 174 may move the backing roller 182 downwardly away from the sealing roller 180 by a user grasping and moving a second handle member 188 and a first handle member 186, respectively. Thus, the first release mechanism 174 and the second release mechanism 176 may facilitate the feeding of an inflatable web 126 between the engaging assembly 170 and the opposing assembly 172, such as in the case of a replacement of the roll of the inflatable web 128 being placed on the spool. In such a case, the new inflatable web may be subsequent threaded through the above-described components of the machine 100 in the machine direction 140. Once the threading is complete, the first handle member 186 and the second handle member 188 are moved back to their operating positions, as shown in FIGS. 2A and 2B, so that the engaging assembly 170 and the opposing assembly 172 are in compressive contact with opposing sides of the inflatable web 126 and ready to begin withdrawing the inflatable structure from the roll and advancing the inflatable structure in the machine direction 140.

As seen in FIGS. 2A and 2B, before the inflatable web 126 travels between the engaging assembly 170 and the opposing assembly 172, the longitudinal edge 130 of the inflatable web 126 is open (e.g., unsealed). This enables the first sheet 136a and the second sheet 136b to separate to locations on opposite sides of the plow 168 and around the nozzle 122 as the inflatable web 126 is advanced in the machine direction 140. However, the first sheet 136a and the second sheet 136b are engaged together by the engaging assembly 170 and the opposing assembly 172 along the longitudinal edge 130 of the inflatable web 126. This occurs as the sealing roller 180 rotates and hence advances the inflatable web 126 between the engaging assembly 170 and the opposing assembly 172 in the machine direction 140, with the inflatable structure being oriented such that the longitudinal edge 130 is adjacent to the machine 100.

The inflation nozzle 122 is positioned to direct fluid 146 into the openings 134 of the inflatable containers 132 as the inflatable web 126 is advanced in the machine direction 140, substantially parallel to the longitudinal edge 130, thereby inflating the inflatable containers 132. By engaging the first sheet 136a and the second sheet 136b of the inflatable web 126 together, the inflation of the inflatable containers 132 may be facilitated as compared to an open edge. For instance, with an open edge, fluid which is directed toward openings in the inflatable structure may partially escape out through the open edge. Further, as the fluid is discharged from the nozzle 122, and also as the escaping fluid passes out through the open edge, the fluid may cause the sheets forming the edge to vibrate as a result of the “reed effect,” which may result in undesirable noise production. Also, due to the vibrations, the openings to the inflatable containers may not remain fully open during inflation. Thus, as a result of both the openings not being fully open and the ability of some of the fluid to escape out of the inflatable structure, a higher fluid pressure may be required to inflate the inflatable containers. However, the use of a higher fluid pressure may not be desirable in some situations in that it may require more complex or expensive components to create the fluid pressure, and further, the increased fluid pressure may exacerbate the noise problem by increasing the vibrations.

Accordingly, the depicted embodiment of the machine 100 can facilitate more efficient inflation of the containers 132 and/or reduction of noise during inflation by engaging the first sheet 136a and the second sheet 136b together along the longitudinal edge 130. This reduces the ability of the fluid 146 to escape through the longitudinal edge 130 and may further reduce any vibrations of the sheets 136a and 136b along the longitudinal edge 130. This may enable the openings 134 of the inflatable containers 132 to remain more fully open. More fluid 146 may also be directed toward the openings 134 and less noise may be produced. Further, as more fluid 146 travels through the openings 134 into the inflatable containers 132 more easily, it may be possible to use a lower fluid pressure to inflate the inflatable containers 132 relative the desired final inflation pressure of the inflated chamber 132.

Various embodiments of a sheet engagement device 118 may be used, such as embodiments using toothed or untoothed belts, as described above. When toothed belts are used, such as the first belt 152 and opposing second belt 162 shown in FIGS. 2A and 2B, the intermeshing of the teeth 154 and 164 may reduce a dimension of the longitudinal edge 130 of the inflatable web 126 in the machine direction 140. The sheet engagement device 118 may also emboss the inflatable web 126 along the longitudinal edge 130 with a plurality of protrusions 194 and indentions 196 corresponding to the teeth 154 and 164. The contracting of the length of the longitudinal edge 130 in the machine direction 140 provides additional benefits because the rest of the inflatable web 126 may also tend to shrink in length in the machine direction when the inflatable containers 132 are filled, which can otherwise distort the openings 134 of the inflatable containers 132 such that they do not remain fully open. Thus, by contracting the length of the longitudinal edge 130, the openings 134 may remain more fully open, which further facilitates inflation of the inflatable containers 132, as described above. In particular, by contracting the length of the longitudinal edge 130 by an amount roughly equivalent to the amount of shortening of length of the inflatable portion of the inflatable web 126 in the machine direction 140, distortion of the openings 134 may be avoided. Additionally, embossing the longitudinal edge 130 further resists noise produced by the “reed effect” by eliminating the planar nature of the longitudinal edge as the longitudinal edge contracts in the machine direction 140.

In alternate embodiments, two belts with untoothed respective first and second external surfaces may be used. In such embodiments, the length of the longitudinal edge 130 of the inflatable web 126 may not be affected. Additionally, such an embodiment may not emboss the inflatable web 126, depending on the pressure applied by the belts to the inflatable structure. However, even when the inflatable web 126 is not embossed, this embodiment may provide beneficial results. For example, the sheet engagement device 118 may extend in the machine direction 140 in such a manner that the untoothed first external surface of the first belt 152 and the untoothed second external surface of the opposing second belt 162 engage the inflatable web 126 therebetween from a location prior to the point at which the inflatable containers 132 pass the nozzle 122 until a point at which the inflatable containers are sealed by the sealing device 116, as described herein. In such an embodiment, the first sheet 136a and the second sheet 136b may remain separated at the longitudinal edge 130 when they exit the machine 100 and may not have embossing thereon.

As also shown in FIG. 2B, the sealing device 116 may be positioned just after the inflation nozzle 122 in the machine direction 140 so that the sealing device 116 substantially contemporaneously seals closed the openings 134 of the inflatable containers 132 as they are inflated. Thus, when the sealing element 184 is heated and the sealing roller 180 and the backing roller 182 counter-rotate against the inflatable web 126, the rotational contact between the sealing element 184 and the inflatable web 126 forms a longitudinal seal 148 as the inflatable structure is advanced in the machine direction 140. In this way, the sealing device 116 seals closed the openings 134 by producing a longitudinal seal 148 between the first sheet 136a and the second sheet 136b (see FIG. 2B). The longitudinal seal 148 also intersects the transverse seals 138 near the ends 142 thereof to enclose the fluid 146 within the inflatable containers 132. In this manner, the inflatable containers 132 of the inflatable web 126 are converted into inflated containers 150. The longitudinal seal 148 may be a continuous seal (e.g., a substantially linear, unbroken seal), which is interrupted only when the sealing device 116 is caused to stop making the seal, or it may form a discontinuous seal. The shape and pattern of the longitudinal seal 148 will depend on the shape and pattern of the sealing element 184, and thus various different seals may be produced as will be apparent to one of ordinary skill in the art.

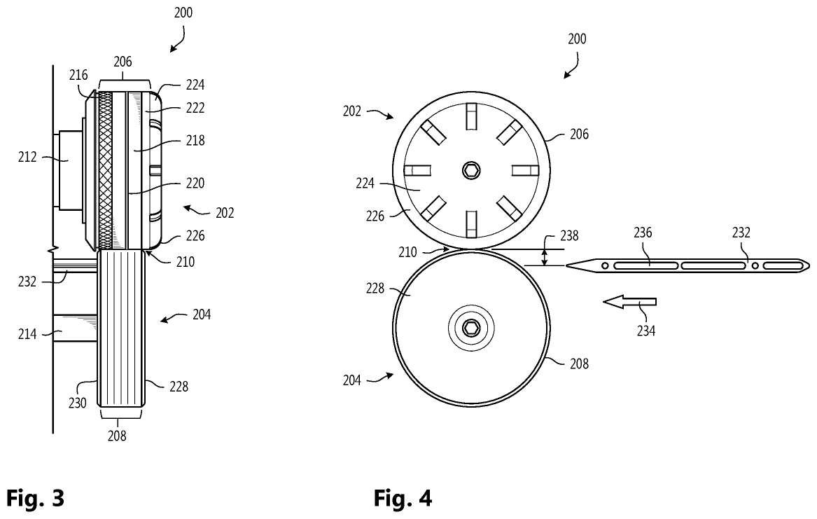

Depicted in FIG. 3 is an embodiment of a system 200 for advancing and sealing a web of inflatable containers. The system 200 is typical of such machines currently in use (e.g., in the machine 10 depicted in FIGS. 1A and 1B and in the machine 100 depicted in FIGS. 2A and 2B). The system 200 includes a sealing roller 202 and a backing roller 204. The sealing roller 202 includes a circumferential surface 206 and the backing roller 204 includes a circumferential surface 208. The sealing roller 202 and the backing roller 204 are arranged to form a nip 210 between the circumferential surface 206 of the sealing roller 202 and the circumferential surface 208 of the backing roller 204.

The sealing roller 202 is coupled to an axle 212 and the backing roller 204 is coupled to an axle 214. In some embodiments, the axles 212 and 214 may be operatively coupled to a motor in a way that, when the motor operates, the motor drives the sealing roller 202 and the backing roller 204 to counterrotate. In some embodiments, only one of the axles 212 and 214 is operatively coupled to a motor in a way that, when the motor operates, the motor drives the corresponding one of the sealing and backing rollers 202 and 204. The other one of the axles 212 and 214 may be permitted to freely rotate such that, when the motor operates to drive the one of the sealing and backing rollers 202 and 204, the interaction between the sealing and backing rollers 202 and 204 causes the sealing and backing rollers 202 and 204 to counterrotate. When one or both of the sealing roller 202 and the backing roller 204 is driven and the longitudinal edge of an inflatable web is located in the nip 210, the counterrotation of the sealing roller 202 and the backing roller 204 advance the inflatable web.

In the depicted embodiment, the sealing roller 202 includes multiple sections across the circumferential surface 206. The sealing roller 202 includes a roughened section 216. In the depicted embodiment, the roughened section 216 is knurled in order to prevent or minimize slippage between the sealing roller 202 and the web.

The sealing roller 202 also includes a sealing section 218 that includes a sealing element 220. In some embodiments, the sealing element 220 is in the form of a wire. The sealing section 218 of the sealing roller 202 may be formed from any material that is capable of withstanding the temperatures generated by the sealing element, such as metal (e.g., aluminum), high-temperature-resistant polymers (e.g., polyimide), ceramics, and the like. A groove may be provided in the circumferential surface of the sealing roller 202 to accommodate the sealing element 220 and keep it in proper position on the circumferential surface 206 during advancement and sealing of the web.

The sealing roller 202 also includes a cap section 222. The cap section 222 is part of a cap 224 that is secured to a side of the sealing roller 202 opposite the axle 212. In the depicted embodiment, the cap 224 also includes a rounded section 226. In some embodiments, the cap 224 is formed from a rigid material, such as a thermoset polymer, a metal, a ceramic, or other material. In the depicted embodiment, the roughened section 216, the sealing section 218, and the cap section 222 of the circumferential surface 206 of the sealing roller 202 have substantially similar diameters. In this way, the web can contact the sealing roller across the circumferential surface 206.

In some embodiments, the portions of the backing roller 204 that include the circumferential surface 208 are formed from a resilient material, such as rubber or RTV silicone. Such a resilient material may increase the traction between the sealing roller 202 and the backing roller 204. In the depicted embodiment, the backing roller 204 includes an inner transverse edge 228 and an outer transverse edge 230. When the system 200 advances an inflatable web that has inflatable containers, the inner transverse edge 228 faces the containers of the web when the web is advanced. In the depicted embodiment, the backing roller 204 has a chamfered corner between the inner transverse edge 228 and the circumferential surface 208 and a chamfered corner between the outer transverse edge 230 and the circumferential surface 208. In the depicted embodiment, the circumferential surface 208 is the surface with a substantially linear profile between the chamfered corners.

The system 200 further includes an inflation nozzle 232 arranged to inflate the containers of the web. FIG. 4 depicts a side view of the system 200 in which the nozzle 232 is visible in greater detail. In the depicted embodiment, as the web is advanced in along a path of travel 234, the nozzle 232 is arranged to inflate the containers of the web before the web is advanced to the sealing roller 202 and the backing roller 204. The inflation nozzle 232 includes outlets 236 through which a fluid (e.g., air or another gas) is inserted into the inflatable containers of the web. In some embodiments, the nozzle 232 is offset from the nip 210 by an offset distance 238. In the depicted embodiment, the nozzle 232 is offset from the nip toward the backing roller 204 such that the web fed along the nozzle 232 will contact the backing roller 204 before the web comes into contact with the sealing roller 202 and the sealing element 220.

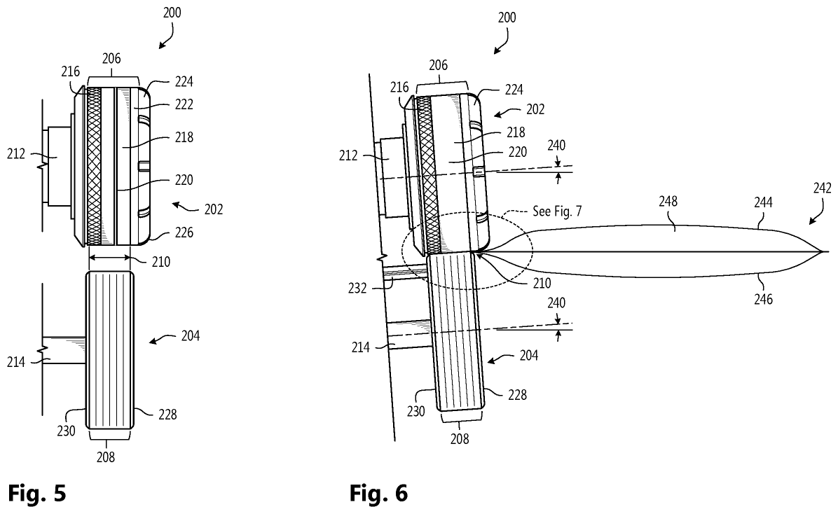

FIG. 5 depicts an exploded front view of the system 200 with the sealing roller 202 and the backing roller 204 spaced apart from each other. In FIG. 5, the width of the nip 210 is more clearly visible. In the depicted embodiment of the sealing roller 202, the nip 210 extends substantially across the roughened section 216 and the sealing section 218. In the depicted embodiment of the backing roller 204, the nip 210 is substantially co-extensive with the circumferential surface 208 of the backing roller 204. However, the circumferential surface 208 of the backing roller 204 does not extend transversally to the cap section 222 of the circumferential surface 206 of the sealing roller 202. Thus, in the depicted embodiment, the nip 210 is not substantially co-extensive with the circumferential surface 206 of the sealing roller 202. Such a width of the of the nip 210 was deemed proper in existing advancing and sealing devices because the roughened section 216 and the sealing section 218 of the sealing roller 202 were deemed to provide the functionality required for advancing and sealing the web, while the cap section 222 of the circumferential surface 206 and, more generally, the cap 224 were not deemed to play a role in the advancement or sealing of the web.

As noted above, some inflation machines to have an upward angle to spools that hold web rolls to aid in web loading and web alignment. In those embodiments, it may also be advantageous for the inflation machines to have advancement and sealing systems that are positioned at similar upward angles to ensure proper inflation and sealing of the web. Depicted in FIG. 6 is an embodiment of the system 200 arranged at an upward angle 240 with respect to horizontal. In some cases, the system 200 may be part of an inflation machine and the system 200 is located on the inflation machine such that the axis of the sealing roller 202 and the axis of the backing roller 204 are arranged at an inclined angle with respect to a surface on which the inflation machine is located (e.g., a horizontal surface). In various embodiments, the degree the upward angle 240 may be between about 1 to about 45 degrees, between about 2 to about 30 degrees, between about 3 to about 20 degrees, and so forth. In the depicted embodiment, the upward angle is about 4 degrees above horizontal.

FIG. 6 also depicted a web 242 that is being advanced and sealed by the system 200. The web 242 includes a first sheet 244 and a second sheet 246 that are juxtaposed and sealed together to form inflatable containers 248. In some embodiments, the web 242 has a closed longitudinal edge (e.g., the edge on the right when viewing FIG. 6). The closed longitudinal edge can be a fold in the film that makes up the web 242 (e.g., when the first and second sheets 244 and 246 are formed from a single film) or a seal in the film that makes up the web 242 (e.g., when the first and second sheets 244 and 246 are formed from a two pieces of film that are sealed together along the closed longitudinal edge). In some embodiments, the web 242 has a longitudinal edge that includes ports for inflating the inflatable containers 248 (e.g., the edge on the left when viewing FIG. 6). In the depicted embodiment, the longitudinal edge of the web 242 that includes the ports is located in the nip 210 between the sealing roller 202 and the backing roller 204. As one or both of the sealing roller 202 and the backing roller 204 are driven (e.g., by a motor) and a portion of the web 242 is located in the nip 210, the web 242 is advanced by the system 200 and the sealing element 220 forms a seal in the web 242 to individually close the ports of the inflatable containers 248. The inflation nozzle 232 introduces fluid into the inflatable containers 248 as the web 242 is advanced and before the web 242 reaches the sealing roller 202 and the backing roller 204.

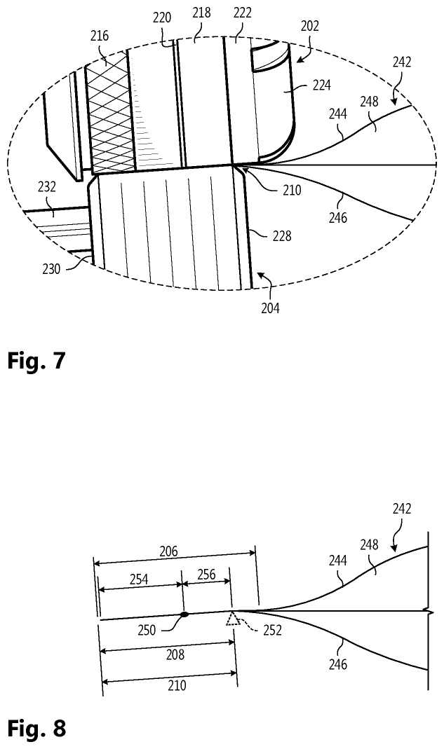

A detail view of the web 242 and the nip 210 between the sealing roller 202 and the backing roller 204 is shown in FIG. 7. FIG. 8 depicts a view of the web 242, as shown in FIG. 7, but with the system 200 removed to more clearly show the state of the web 242. In the depicted embodiment, a portion of the web 242 is in the nip 210 and a portion of the web 242 that includes the inflated chamber 248 extends away from the nip 210 (e.g., extends to the right when viewing FIGS. 6 and 7). The sealing element 220 forms a seal 250 in the web 242 to close the port of the inflatable chamber 248.

One of the problematic aspects of the system 200 in the depicted embodiments is that the seal 250 does not always form properly. In one example, the inflatable chamber 248 is over-inflated when the web 242 enters the nip 210, the force from the pressure in the inflatable chamber 248 may cause excess force on portions of the first and second sheets 244 and 246 where the seal 250 is being formed. Under certain conditions such a force may cause physical distortion of the seal 250 before the seal 250 has cooled, tearing of one or both of the first and second sheets 244 and 246 near the seal 250, or other defects. In another example, the material of the film in the first and second sheets 244 and 246 may not be capable of withstanding the forces experienced by the web 242 during the sealing and advancement by the system 200. Many efforts are being made to reduce the amount of polymer-based materials that are used, such materials can come in the form of modified plastic films (e.g., very thin plastic films) or plastic film substitutes (e.g., biodegradable films or recyclable films). However, these non-traditional films are especially incapable of withstanding such forces, which could also cause physical distortion of the seal 250 before the seal 250 has cooled, tearing of one or both of the first and second sheets 244 and 246 near the seal 250, or other defects. Regardless of how the defects occur, these defects may result in loss of integrity of the seal 250 and/or deflation of the inflatable chamber 248. However, the causes of such defects and ways to address these causes were not known or understood before the present disclosure.

FIG. 8 also depicts a transverse location 252 on the web 242. The transverse direction is the direction substantially perpendicular to the longitudinal direction (e.g., the left-right directions when viewing FIG. 8). In the depicted embodiment, the transverse location 252 is the farthest point away from the longitudinal edge at which the web 242 is in contact with at least one of the sealing and backing rollers 202 and 204. As shown, the circumferential surface 208 and the nip 210 are essentially co-extensive and the transverse location 252 is located substantially at the edge of the circumferential surface 208 and the nip 210. Also depicted in FIG. 8 are both a transverse distance 254 between the longitudinal edge of the web 242 and the seal 250 and a transverse distance 256 between the seal 250 and the transverse location 252 at which the web 242 is in contact with at least one of the sealing and backing rollers 202 and 204. As can be seen in the depicted embodiment, the transverse distance 256 between the seal 250 and the transverse location 252 at which the web 242 is in contact with at least one of the sealing and backing rollers 202 and 204 is less than the transverse distance 254 between the longitudinal edge of the web 242 and the seal 250.

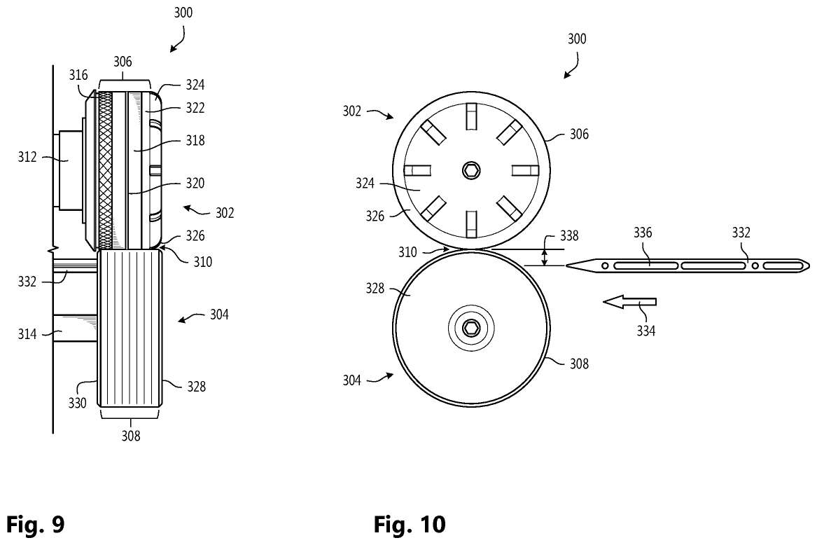

Depicted in FIGS. 9-14 are an embodiment of a system 300 for advancing and sealing a web of inflatable containers that addresses the problems with the system 200 described above. The system 300 includes a sealing roller 302 and a backing roller 304. The sealing roller 302 includes a circumferential surface 306 and the backing roller 304 includes a circumferential surface 308. The sealing roller 302 and the backing roller 304 are arranged to form a nip 310 between the circumferential surface 306 of the sealing roller 302 and the circumferential surface 308 of the backing roller 304.

The sealing roller 302 is coupled to an axle 312 and the backing roller 304 is coupled to an axle 314. In some embodiments, the axles 312 and 314 may be operatively coupled to a motor in a way that, when the motor operates, the motor drives the sealing roller 302 and the backing roller 304 to counterrotate. In some embodiments, only one of the axles 312 and 314 is operatively coupled to a motor in a way that, when the motor operates, the motor drives the corresponding one of the sealing and backing rollers 302 and 304. The other one of the axles 312 and 314 may be permitted to freely rotate such that, when the motor operates to drive the one of the sealing and backing rollers 302 and 304, the interaction between the sealing and backing rollers 302 and 304 causes the sealing and backing rollers 302 and 304 to counterrotate. When one or both of the sealing roller 302 and the backing roller 304 is driven and the longitudinal edge of an inflatable web is located in the nip 310, the counterrotation of the sealing roller 302 and the backing roller 304 advance the inflatable web.

In the depicted embodiment, the sealing roller 302 includes multiple sections across the circumferential surface 306. The sealing roller 302 includes a roughened section 316. In the depicted embodiment, the roughened section 316 is knurled in order to prevent or minimize slippage between the sealing roller 302 and the web.

The sealing roller 302 also includes a sealing section 318 that includes a sealing element 320. In some embodiments, the sealing element 320 is in the form of a wire. The sealing section 318 of the sealing roller 302 may be formed from any material that is capable of withstanding the temperatures generated by the sealing element, such as metal (e.g., aluminum), high-temperature-resistant polymers (e.g., polyimide), ceramics, and the like. A groove may be provided in the circumferential surface of the sealing roller 302 to accommodate the sealing element 320 and keep it in proper position on the circumferential surface 306 during advancement and sealing of the web. In some embodiments, the sealing element 320 has a helical shape around the circumferential surface 306 of the sealing roller 320. In some embodiments, the sealing element 320 has an annular shape around the circumferential surface 306 of the sealing roller 320.

The sealing roller 302 also includes a cap section 322. The cap section 322 is part of a cap 324 that is secured to a side of the sealing roller 302 opposite the axle 312. In the depicted embodiment, the cap 324 also includes a rounded section 326. In some embodiments, the cap 324 is formed from a rigid material, such as a thermoset polymer, a metal, a ceramic, or other material. In the depicted embodiment, the roughened section 316, the sealing section 318, and the cap section 322 of the circumferential surface 306 of the sealing roller 302 have substantially similar diameters. In this way, the web can contact the sealing roller across the circumferential surface 306.

In some embodiments, the portions of the backing roller 304 that include the circumferential surface 308 are formed from a resilient material, such as rubber or RTV silicone. Such a resilient material may increase the traction between the sealing roller 302 and the backing roller 304. In the depicted embodiment, the backing roller 304 includes an inner transverse edge 328 and an outer transverse edge 330. In the depicted embodiment, the backing roller 304 is located with respect to the sealing roller 302 such that the inner transverse edge 328 is positioned farther away from the sealing element 320 than the outer transverse edge 330. When the system 300 advances an inflatable web that has inflatable containers, the inner transverse edge 328 faces the containers of the web when the web is advanced. In the depicted embodiment, the backing roller 304 has a chamfered corner between the inner transverse edge 328 and the circumferential surface 308 and a chamfered corner between the outer transverse edge 330 and the circumferential surface 308. In the depicted embodiment, the circumferential surface 308 is the surface with a substantially linear profile between the chamfered corners. In the depicted embodiment, the circumferential surface 308 of the backing roller 304 extends axially farther to the right (e.g., into the web when the web is in the nip 310) than the circumferential surface 306 of the sealing roller 302 extends axially to the right (e.g., into the web when the web is in the nip 310). In this way, when a longitudinal edge of a web is in the nip 310, the backing roller 304 contacts the web at a transverse location that is farther away from the longitudinal edge of web than the sealing roller 302 contacts the web. In some embodiments, a percentage of the circumferential surface 308 of the backing roller 304 that extends beyond the nip 310 is greater than or equal to at least one of 5%, 7.5%, 10%, or 12.5%.

The system 300 further includes an inflation nozzle 332 arranged to inflate the containers of the web. FIG. 10 depicts a side view of the system 300 in which the nozzle 332 is visible in greater detail. In the depicted embodiment, as the web is advanced in along a path of travel 334, the nozzle 332 is arranged to inflate the containers of the web before the web is advanced to the sealing roller 302 and the backing roller 304. The inflation nozzle 332 includes outlets 336 through which a fluid (e.g., air or another gas) is inserted into the inflatable containers of the web. In some embodiments, the nozzle 332 is offset from the nip 310 by an offset distance 338. In the depicted embodiment, the nozzle 332 is offset from the nip toward the backing roller 304 such that the web fed along the nozzle 332 will contact the backing roller 304 before the web comes into contact with the sealing roller 302 and the sealing element 320.

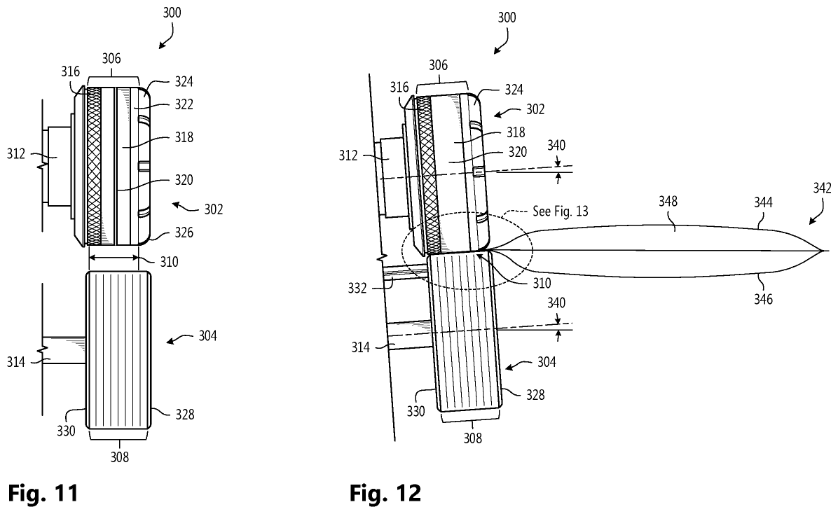

FIG. 11 depicts an exploded front view of the system 300 with the sealing roller 302 and the backing roller 304 spaced apart from each other. In FIG. 11, the width of the nip 310 is more clearly visible. In the depicted embodiment of the sealing roller 302, the nip 310 extends substantially across the roughened section 316, the sealing section 318, and the cap section 322 of the circumferential surface 306. The nip 310 is also substantially co-extensive with the circumferential surface 306 of the sealing roller 302. The circumferential surface 308 of the backing roller 304 extends transversally beyond the cap section 322 of the circumferential surface 306 of the sealing roller 302. Thus, in the depicted embodiment, the nip 310 is not substantially co-extensive with the circumferential surface 308 of the backing roller 304. The benefits of this arrangement of the backing roller 304 are discussed below.

As noted above, some inflation machines to have an upward angle to spools that hold web rolls to aid in web loading and web alignment. In those embodiments, it may also be advantageous for the inflation machines to have advancement and sealing systems that are positioned at similar upward angles to ensure proper inflation and sealing of the web. Depicted in FIG. 12 is an embodiment of the system 300 located at an upward angle 340 with respect to horizontal. In some cases, the system 300 may be part of an inflation machine and the system 300 is located on the inflation machine such that the axis of the sealing roller 302 and the axis of the backing roller 304 are arranged at an inclined angle with respect to a surface on which the inflation machine is located (e.g., a horizontal surface). In various embodiments, the degree the upward angle 340 may be between about 1 to about 45 degrees, between about 3 to about 30 degrees, between about 3 to about 30 degrees, and so forth. In the depicted embodiment, the upward angle is about 4 degrees above horizontal. It will be understood by those of ordinary skill in the art that an upward angle is not a necessary aspect of the system 300 and that the axes of the sealing and backing rollers 302 and 304 could be arranged horizontally or at any other angle.

FIG. 12 also depicted a web 342 that is being advanced and sealed by the machine 300. The web 342 includes a first sheet 344 and a second sheet 346 that are juxtaposed and sealed together to form inflatable containers 348. In some embodiments, the web 342 has a closed longitudinal edge (e.g., the edge on the right when viewing FIG. 12). The closed longitudinal edge can be a fold in the film that makes up the web 342 (e.g., when the first and second sheets 344 and 346 are formed from a single film) or a seal in the film that makes up the web 342 (e.g., when the first and second sheets 344 and 346 are formed from a two pieces of film that are sealed together along the closed longitudinal edge). In some embodiments, the web 342 has a longitudinal edge that includes ports for inflating the inflatable containers 348 (e.g., the edge on the left when viewing FIG. 6). In the depicted embodiment, the longitudinal edge of the web 342 that includes the ports is located in the nip 310 between the sealing roller 302 and the backing roller 304. As one or both of the sealing roller 302 and the backing roller 304 are driven (e.g., by a motor) and a portion of the web 342 is located in the nip 310, the web 342 is advanced by the system 300 and the sealing element 318 forms a seal in the web 342 to individually close the ports of the inflatable containers 348. The inflation nozzle 332 introduces fluid into the inflatable containers 348 as the web 342 is advanced and before the web 342 reaches the sealing roller 302 and the backing roller 304.

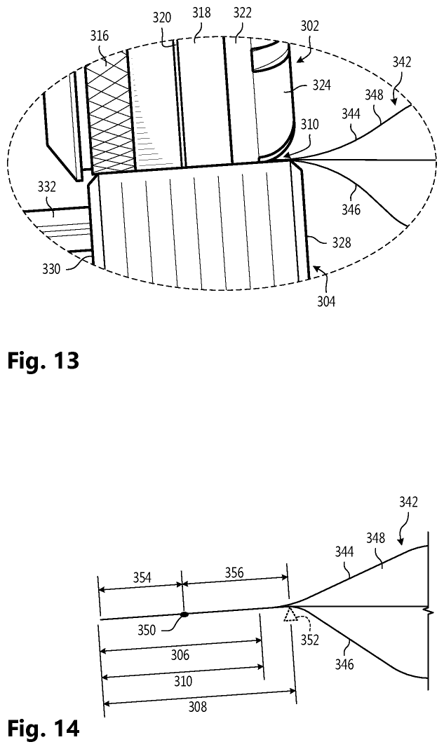

A detail view of the web 342 and the nip 310 between the sealing roller 302 and the backing roller 304 is shown in FIG. 13. FIG. 14 depicts a view of the web 342, as shown in

FIG. 13, but with the system 300 removed to more clearly show the state of the web 342. In the depicted embodiment, a portion of the web 342 is in the nip 310 and a portion of the web 342 that includes the inflated chamber 348 extends away from the nip 310 (e.g., extends to the right when viewing FIGS. 12 and 13). The sealing element 320 forms a seal 350 in the web 342 to close the port of the inflatable chamber 348.

FIG. 14 also depicts a transverse location 352 on the web 342. The transverse direction is the direction substantially perpendicular to the longitudinal direction (e.g., the left-right directions when viewing FIG. 14). In the depicted embodiment, the transverse location 352 is the farthest point away from the longitudinal edge at which the web 342 is in contact with at least one of the sealing and backing rollers 302 and 304. As shown, the circumferential surface 306 and the nip 310 are essentially co-extensive. However, unlike the transverse location 252 shown in FIG. 8, the transverse location 352 is located outside of the nip 310. In the depicted embodiment, the transverse location 352 is located at the edge of the circumferential surface 308 of the backing roller 304. Also depicted in FIG. 14 are both a transverse distance 354 between the longitudinal edge of the web 342 and the seal 350 and a transverse distance 356 between the seal 350 and the transverse location 352 at which the web 342 is in contact with at least one of the sealing and backing rollers 302 and 304. As can be seen in the depicted embodiment, the transverse distance 356 between the seal 350 and the transverse location 352 at which the web 342 is in contact with at least one of the sealing and backing rollers 302 and 304 is greater than the transverse distance 354 between the longitudinal edge of the web 342 and the seal 350.

The arrangement of the system 300 addresses the above-identified issues with the system 200 in a number of ways. In one example, the backing roller 304 is wider than the backing roller 204, which means that the mass of the backing roller 304 is greater than the mass of the backing roller 204. The greater mass of the backing roller 304 induces a higher rate of heat transfer from the web 342 to the backing roller 304. A higher rate of heat transfer means that the seal 350 cools more quickly and cures from a molten or soft state to a hardened state more quickly. Thus, the amount of time for any damage to the seal 350 while the seal 350 is in a molten or soft state is reduced.

In another example, the transverse location 352 at which the web 342 is in contact with at least one of the sealing and backing rollers 302 and 304 is outside of the nip 310. The transverse location 352 at which the web 342 is in contact with at least one of the sealing and backing rollers 302 and 304 is a pressure point or stress point where any pressure or stress induced in the web 342 will be concentrated. By removing the transverse location 352 from the nip 310, the pressure point or stress point is outside of the nip 310, the web 342 is able to flex and stretch in the area between the nip 310 and the transverse location 352 such that any force on the portion of the web 342 in the nip 310 is reduced.

In another example, the transverse location 352 at which the web 342 is in contact with at least one of the sealing and backing rollers 302 and 304 is farther away from the seal 350 than the transverse location 252 is away from the seal 250 in FIG. 8. The greater distance between the transverse location 352 and the seal 350 reduces the probability of any force concentrated at the transverse location 352 would be sufficient to cause deformation or rupture of the web 342 at the seal 350. In this way, it is much more likely that the seal 350 will have an opportunity to cool and harden before experiencing a force that would otherwise damage the seal 350 in a molten or soft state.

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items.

Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

What is claimed is:

1. A system configured to advance and seal a web of inflatable containers, wherein the containers include ports along a longitudinal edge of the web, the system comprising:
a sealing roller that includes a sealing element, wherein the sealing element is located around a circumferential surface of the sealing roller; and
a backing roller positioned with respect to the sealing roller to form a nip between a circumferential surface of the backing roller and the circumferential surface of the sealing roller;
wherein at least one of the sealing roller and the backing roller is driven such that, when the longitudinal edge of the web is located in the nip, the sealing roller and the backing roller counterrotate to advance the web;
wherein the circumferential surface of the backing roller extends axially farther into the web than the circumferential surface of the sealing roller extends axially into the web such that backing roller contacts the web at a transverse location that is farther away from the longitudinal edge of web than the sealing roller contacts the web.

2. The system of claim 1, wherein the backing roller comprises a rubber material and wherein the circumferential surface of the backing roller is made from the rubber material.

3. The system of claim 1, wherein the sealing roller and the backing roller are arranged such that an axis of the sealing roller and an axis of the backing roller are substantially parallel to each other.

4. The system of claim 3, wherein the system is part of an inflation machine, and wherein the axis of the sealing roller and the axis of the backing roller are arranged at an inclined angle with respect to a surface on which the inflation machine is located.

5. The system of claim 4, wherein the surface on which the inflation machine is located is substantially horizontal.

6. The system of claim 1, wherein the backing roller includes an inner transverse edge and an outer transverse edge, and wherein the inner transverse edge faces the containers of the web when the web is advanced, and wherein the backing roller is located with respect to the sealing roller such that the inner transverse edge is positioned farther away from the sealing element than the outer transverse edge.

7. The system of claim 1, wherein the circumferential surface of the backing roller extends beyond the nip between the circumferential surface of the backing roller and the circumferential surface of the sealing roller.

8. The system of claim 7, wherein a percentage of the circumferential surface of the backing roller that extends beyond the nip is greater than or equal to at least one of 5%, 7.5%, 10%, or 12.5%.

9. The system of claim 1, further comprising:
a nozzle arranged to inflate the containers of the web before the web is advanced to the sealing roller and the backing roller.

10. The system of claim 9, wherein the nozzle is offset with respect to the nip between the circumferential surface of the backing roller and the circumferential surface of the sealing roller such that, as the web is advanced by the sealing roller and the backing roller, the web contacts the backing roller before contacting the sealing roller.

11. The system of claim 1, wherein the sealing element has a helical shape around the circumferential surface of the sealing roller.

12. The system of claim 1, wherein the sealing element has an annular shape around the circumferential surface of the sealing roller.
